(19) United States
(12) Patent Application Publication
(10) Pub. No.: US 2026/0088692 A1
(43) Pub. Date: Mar. 26, 2026

(54) LINEAR VIBRATION GENERATING DEVICE

(71) Applicant: JAHWA ELECTRONICS CO., LTD., Cheongju-si, Chungcheongbuk-do (KR)

(72) Inventors: Won Gook LEE, Cheongju-si (KR); Seok Min KIM, Cheongju-si (KR); Min Goo LEE, Cheongju-si (KR); Young Bin CHONG, Cheongju-si (KR); Kyung Hoon JO, Cheongju-si (KR); Nam Jin CHOI, Cheongju-si (KR)

(73) Assignee: JAHWA ELECTRONICS CO., LTD., Cheongju-si, Chungcheongbuk-do (KR)

(21) Appl. No.: 18/997,867

(22) PCT Filed: May 17, 2024
(86) PCT No.: PCT/KR2024/006748

§ 371 Date: Jan. 23, 2025

(30) Foreign Application Priority Data
May 19, 2023 (KR) 10-2023-0065096

(51) Int. Cl. H02K 33/18

(52) U.S. Cl. CPC H02K 33/18

(57) ABSTRACT

A linear vibration generating apparatus includes a casing coupled to a lower cover so that a mounting space is formed inside the casing, a vibration body configured to vibrate in the mounting space in a first direction, a fixed body including a coil surrounded by the vibration body and including a yoke to which the coil is wound, and a pair of elastic bodies elastically supporting vibrations of the vibration body from between the casing and the vibration body. The vibration body includes a frame part which surrounds the fixed body and to which each of the pair of elastic bodies is connected, and includes a plurality of magnets mounted on an inner surface of the frame part facing the fixed body.

### TECHNICAL FIELD

The present disclosure relates to a linear vibration generating apparatus. More particularly, the present disclosure relates to a linear vibration generating apparatus configured to generate vibrations due to a fluctuation of a vibration body in a horizontal direction by an interaction between an electric field generated by a coil and a magnetic field generated by a magnet.

### BACKGROUND

Generally, as a vibration generating apparatus that receives signal feedback, an eccentric rotational vibration generating apparatus has been commonly used. However, this technology does not guarantee a long lifespan, does not have a rapid responsiveness, and has limitations in realizing various vibration modes. Therefore, there is a disadvantage that such technology does not satisfy needs of consumers in a trend of rapidly popularizing touch-operated smartphones.

Accordingly, a linear vibration generating apparatus device configured to generate vibrations by linearly shaking a weighted body has been developed. The linear vibration generating apparatus basically uses a primary vibration system. More specifically, the linear vibration generating apparatus has a principle in which vibrations are generated by shaking the weighted body in a horizontal direction with a force (Lorenz force) according to an interaction between an electric field generated by a coil and a magnetic field by a permanent magnet.

The linear vibration generating apparatus is designed such that an electromagnetic force generated between the coil and the magnet and a physical elastic force provided by an elastic body have mutual resonant characteristics. When an electromagnetic force is generated by applying a power source having a frequency component having a time-variant characteristic is applied to the coil, the generated electromagnetic force and an elastic force of the elastic body interact with each other, and a vibration body reciprocates at a high speed in the horizontal direction, so that vibrations are generated.

However, in most of the conventional linear vibration generating apparatuses, since there is an imperfection of a magnetic closed circuit implementation structurally, there is a disadvantage that the vibration performance is reduced and the reaction speed is slow due to a large amount of magnetic force line leakage. Furthermore, there is a problem that the vibration performance is highly variable even in a product of the same specification according to the production deviation of the elastic body or the fixing position of the elastic body in the assembly process.

In addition, problems have been pointed out in terms of durability of the product, such as that a connection part where the elastic body and the vibration body are connected to each other is structurally fragile, so that the elastic body is easily broken.

### Document of Related Art

(Patent Document 1) Japanese Patent Application Publication No. 2019-062627 (published on Apr. 18, 2019)

### SUMMARY

Accordingly, the present disclosure has been made keeping in mind the above problems occurring in the related art, and an objective of the present disclosure is to provide a linear vibration generating apparatus capable of suppressing or minimizing magnetic leakage and capable of realizing a more increased vibration performance.

Another objective of the present disclosure is to provide a linear vibration generating apparatus configured such that a fixing position of an elastic body is capable of being arbitrarily adjusted during an assembly process so that a vibration frequency band is capable of being easily adjusted.

Still another objective of the present disclosure is to provide a linear vibration generating apparatus configured such that durability of a connection region where an elastic body and a vibration body are interconnected is capable of being increased.

In order to achieve the objectives described above, according to an aspect of the present disclosure, there is provided a linear vibration generating apparatus including:
a casing coupled to a lower cover so that a mounting space is formed inside the casing;
a vibration body configured to vibrate in the mounting space in a first direction;
a fixed body including a coil surrounded by the vibration body and including a yoke to which the coil is wound; and
a pair of elastic bodies elastically supporting vibrations of the vibration body from between the casing and the vibration body,
wherein the vibration body includes:
a frame part which surrounds the fixed body and to which each of the pair of elastic bodies is connected; and
a plurality of magnets mounted on an inner surface of the frame part facing the fixed body,
wherein the frame part is formed of a first frame and a second frame that are coupled to each other such that a part of the first frame and a part of the second frame overlap each other from opposite sides of the fixed body, and
each part of a movable end of the elastic bodies is inserted into and fixed to a gap at a region where the first frame and the second frame overlap each other.

According to an aspect of the present disclosure, the pair of elastic bodies may be formed of a first elastic body elastically supporting the vibrations of the vibration body on a first side of the vibration body and a second elastic body elastically supporting the vibrations of the vibration body on a second side of the vibration body. At this time, each of the first elastic body and the second elastic body may include: a fixed end coupled to the casing; a movable end coupled to the gap such that a part of the movable end is inserted into the gap; and a connection part connecting the movable end and the fixed end to each other. Furthermore, positions on a plane of the fixed end and the movable end of the first elastic body are opposite to positions on a plane of the fixed end and the movable end of the second elastic body.

At this time, by adjusting an insertion length of the movable end that is inserted into the gap, a vibration frequency band of the vibration body is capable of being adjusted.

In addition, according to an aspect of the present disclosure, each of the first frame and the second frame may include: a pair of fastening frames disposed parallel to each other with the fixed body interposed therebetween; and a connection frame interconnecting each first side end portion of the pair of fastening frames, wherein the fastening frames of the first frame and the fastening frames of the second frame may be coupled to each other so as to be parallel to each other and to overlap each other.

Preferably, a first fastening hole for fastening the first frame to the second frame may be formed in a first side edge region of the first frame, and a second fastening hole for fastening the second frame to the first frame may be formed in a second side edge region of the second frame, the second side edge region facing the first fastening hole in a diagonal direction.

In addition, according to an aspect of the present disclosure, the plurality of magnets may include: two first magnets which are mounted on a recessed surface part formed on the first frame corresponding to a front surface part of the fixed body and which are mounted on a recessed surface part formed on the second frame corresponding to a rear surface part of the fixed body, respectively; and two second magnets which are mounted on a surface of one fastening frame that is directly facing a first side surface part of the fixed body among the pair of fastening frames of the first frame and which are mounted on a surface of one fastening frame that is directly facing a second side surface part of the fixed body among the pair of fastening frames of the second frame, respectively.

Here, as a preferred example, the first magnet may be disposed such that an S-pole is positioned on a side facing the fixed body and an N-pole is positioned on an opposite side, and the second magnet may be disposed such that an N-pole is positioned on a side facing the fixed body and an S-pole is positioned on an opposite side.

Here, as another preferred example, the first magnet may be disposed such that the S-pole is positioned on the side facing the fixed body and the N-pole is positioned on the opposite side, and the second magnet may be provided as a polarization magnet in which magnetic poles are divided into a plurality of magnetic poles.

When the second magnet is provided as the polarization magnet in which the magnetic poles are divided into the plurality of magnetic poles, the second magnet may be formed of a magnet center part and magnet side parts positioned at opposite sides of the magnet center part. Furthermore, the magnet center part may be configured such that an N-pole is formed at a side facing the fixed body and an S-pole is formed at an opposite side, and the magnet side parts may be configured such that an N-pole is formed at a side adjacent to the magnet center part and an S-pole is formed at a side farther from the magnet center part.

Meanwhile, according to an aspect of the present disclosure, the linear vibration generating apparatus may further include a support part supporting the fixed body formed of the coil and the yoke so that the fixed body is positioned at a center of the mounting space.

At this time, the support part may include: a pair of lower support units provided on the lower cover; and a pair of upper support units provided on the casing such that the pair of upper support units corresponds to the pair of lower support units. Furthermore, the pair of lower support units and the pair of upper support units may be formed by cutting a part of the lower cover and a part of the casing and then bending the cut parts toward the mounting space.

Preferably, according to an aspect of the present disclosure, the lower cover, the casing, and the frame part may be formed of metal having magnetic properties.

According to an embodiment of the present disclosure, since a structure in which the magnetic substance frame (the first frame and the second frame) included in the vibration body completely surrounds the fixed body is realized, a magnetic closed circuit is formed in an XY plane direction (see FIG. 4), and the fixed body is supported on the support part formed on the magnetic substance casing and the lower cover, so that a magnetic closed circuit may be formed in an XZ plane direction (see FIG. 3).

Accordingly, since a more advanced magnetic shielding effect is realized, magnetic leakage to the outside of the casing may be suppressed or minimized. As a result, the drive force according to the interaction between the magnet and the coil is increased, so that the attraction force, the repulsive force, and the propulsive force of the vibration body against the fixed body are increased, thereby being capable of increasing the overall vibration performance including the vibration force and the reaction speed (responsiveness).

In addition, since the structure in which the part of the elastic body is inserted into and fixed to the overlapping region of the magnetic substance frame is realized, there is an advantage that the vibration frequency band of the vibration body is capable of being adjusted during the product assembly process by adjusting the insertion depth of the elastic body, and also the fixing position of the elastic body to the vibration body is capable of being adjusted to a position capable of realizing the intended vibration characteristic, so that the variability of vibration performance according to component dispersion may be minimized.

In addition, due to a unique connection structure (a sandwich-type connection structure) in which the part of the elastic body is inserted into and fixed to the overlapping region of the magnetic substance frame, durability problems such as a fracture of the elastic body frequently occurring at a connection region where the elastic body and the vibration body are connected to each other may be clearly and precisely resolved.

### BRIEF DESCRIPTION OF DRAWINGS

FIG. 1 is a perspective view illustrating a coupled state of a linear vibration generating apparatus according to an embodiment of the present disclosure.

FIG. 2 is an exploded perspective view illustrating the linear vibration generating apparatus according to an embodiment of the present disclosure.

FIG. 3 is a cross-sectional view illustrating the linear vibration generating apparatus in FIG. 1 as viewed along a line A-A direction.

FIG. 4 is a cross-sectional plan view illustrating the linear vibration generating apparatus in FIG. 1 as viewed along a line B-B direction.

FIG. 5(a) and FIG. 5(b) shows enlarged views of main configurations of the present disclosure, the enlarged views enlarging a part “C” and a part “D” in FIG. 4.

FIG. 6 is an enlarged view of the main configurations of the present disclosure, the enlarged view illustrating a preferred magnetic pole arrangement of magnets forming a vibration body.

FIG. 7 is an enlarged view of the main configuration of the present disclosure, the enlarged view illustrating another preferred magnetic pole arrangement of the magnets forming the vibration body.

### DETAILED DESCRIPTION

Hereinafter, an exemplary embodiment of the present disclosure will be described in detail.

The terms used in the present specification are only used to describe specific embodiments, and are not intended to limit the present disclosure. As used herein, the singular forms are intended to include the plural forms as well, unless the context clearly indicates otherwise.

It is to be understood that terms such as “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

In addition, terms “first”, “second”, and so on can be used to describe various elements, but the elements are not to be construed as being limited to the terms. The terms are used only for the purpose of distinguishing one constituent element from another constituent element.

In addition, the terms “ . . . part”, “ . . . unit”, “ . . . module”, and the like described herein may mean a unit for processing at least one function or operation, and they may be implemented in hardware, software, or a combination of hardware and software.

In addition, in the description of the present disclosure, the term “substantially” should be understood to the extent that the recited properties, parameters, or values do not need to be precisely achieved, and that deviations, changes, or characteristics including tolerances, measurement errors, limits of measurement accuracy, and other factors known to those skilled in the art do not exclude an effect intended to be provided.

The present embodiments to be described below are applied to an “apparatus receiving signal feedback through vibration”, and a portable terminal refers to a portable user device. However, this is only a general term, and it is noted that the present embodiment may be applicable to various devices or fields of a mobile phone, a palm sized Personal Computer (PC), a Personal Communication System (PCS), a Personal Digital Assistant (PDA), a Hand-held PC (HPC), a smartphone, a wireless Local Area Network (LAN) terminal, a laptop computer, a netbook, a tablet personal computer, a non-mobile game console, a Virtual Reality (VR) device, a vehicle, and the like.

Therefore, the use of the term “apparatus receiving signal feedback through vibration” should not be used to limit the application of the present embodiment to a specific type of apparatus.

Hereinafter, in the description with reference to the accompanying drawings, the same reference numerals will be assigned to the same components for the same drawings, and the overlapping description thereof will be omitted. In the description of the present disclosure, when it is determined that a detailed description of a related known technology may unnecessarily obfuscate the gist of the present disclosure, the detailed description thereof will be omitted.

Before describing the present disclosure, direction-related terms to be used later will be defined as follows. Among the direction-related terms used hereinafter, a first direction (an x-axis direction in the drawings) is defined as a direction in which a vibration body vibrates with respect to a fixed body in the drawings, and a second direction (a y-axis direction in the drawings) is defined as a direction orthogonal to the first direction. In addition, a third direction (a z-axis direction in the drawings) is defined as a direction orthogonal to the first direction on a plane perpendicular to the second direction.

An exemplary embodiment of the present disclosure will be described in detail with reference to the accompanying drawings.

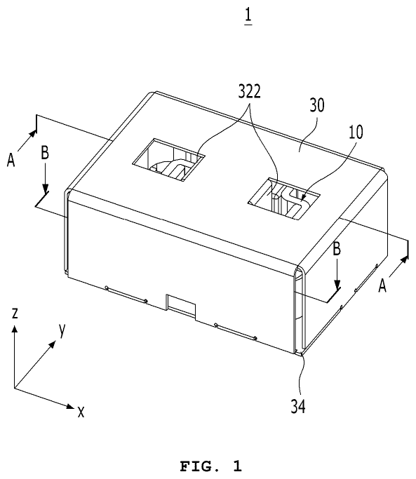

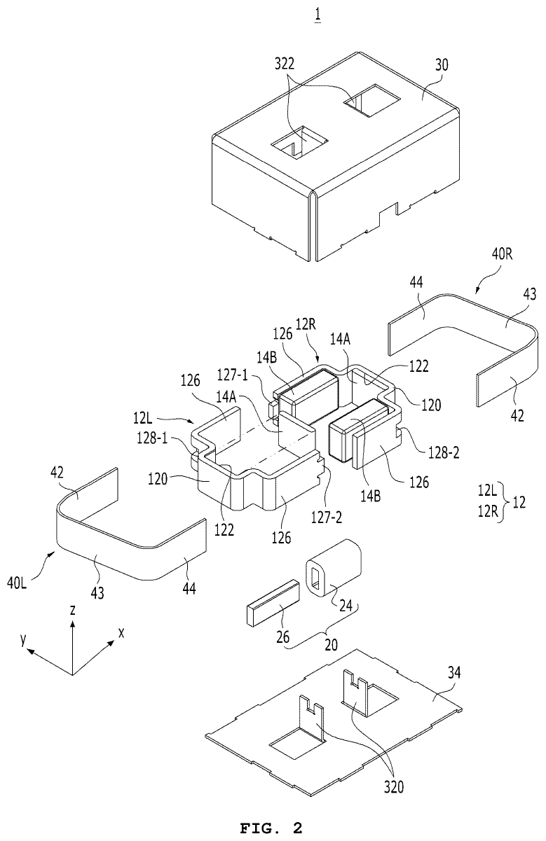

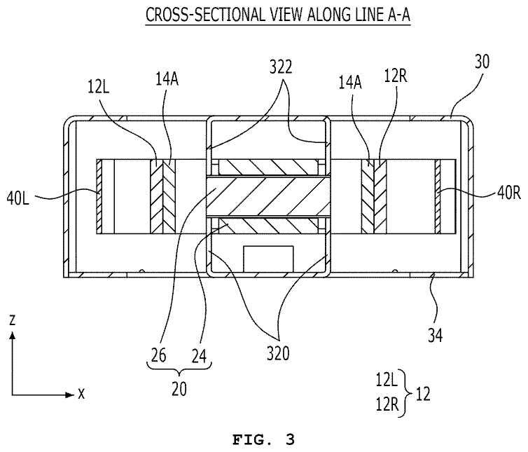

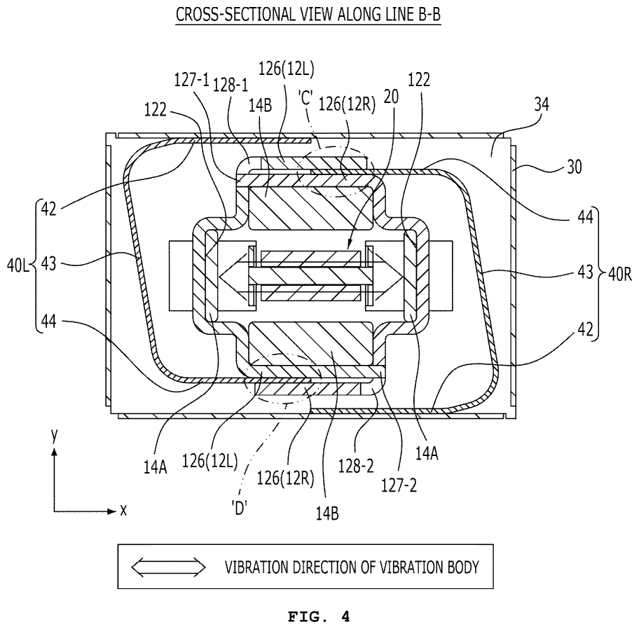

FIG. 1 is a perspective view illustrating a coupled state of a linear vibration generating apparatus according to an embodiment of the present disclosure, and FIG. 2 is an exploded perspective view illustrating the linear vibration generating apparatus according to an embodiment of the present disclosure. In addition, FIG. 3 is a cross-sectional view illustrating the linear vibration generating apparatus in FIG. 1 as viewed along a line A-A direction, and FIG. 4 is a cross-sectional plan view illustrating the linear vibration generating apparatus in FIG. 1 as viewed along a line B-B direction.

Referring to FIG. 1 to FIG. 4, a linear vibration generating apparatus 1 according to an embodiment of the present disclosure may largely include a vibration body 10 and a fixed body 20. Here, the vibration body 10 and the fixed body 20 are relative concepts from one another, wherein the fixed body 20 means a part fixed with respect to the vibration body 10, and the vibration body 10 means a part vibrating with respect to the fixed body 20.

The vibration body 10 is mounted in a casing 30 constituting an external appearance of the apparatus, and may perform a linear motion (vibration) in which a movement direction is changed with respect to the first direction by an interaction with the fixed body 20. Furthermore, a pair of elastic bodies 40L and 40R between the vibration body 10 and the casing 30 elastically support the vibrations from opposite sides of the vibration body 10. That is, the pair of elastic bodies 40L and 40R elastically support the first direction linear movement of the vibration body 10 in which the movement direction is changed.

As an example in the drawings, the casing 30 may have a rectangular structure in which a plane shape having a length in the first direction longer than a width in the second direction is rectangular, and a lower cover 34 may be coupled to an open portion of a lower portion of the casing 30.

The vibration body 10, the fixed body 20, and the elastic bodies 40L and 40R may be mounted in a mounting space (an internal space partitioned by the casing and the lower cover) formed by coupling the casing 30 and the lower cover 34 to each other.

The fixed body 20 includes a coil 24 and a yoke 26. The coil 24 is electrically connected to a substrate (not illustrated) mounted on the lower cover 34, and may be structurally surrounded by the vibration body 10 in the mounting space. In addition, in a state in which the yoke 26 is surrounded by the coil 24, the yoke 26 may be floated from the lower cover 34 by a support part 32, and the yoke 26 may be positioned at the center of the mounting space.

The support part 32 supporting the fixed body 20 may include a pair of lower support units 320 which is provided on the lower cover 34 and which is disposed by being spaced apart from each other in the first direction, and may include a pair of upper support units 322 provided on the casing 30 such that the pair of upper support units 322 corresponds to the pair of lower support units 320. At this time, the lower support unit 320 and the upper support unit 322 may be configurations respectively formed by cutting a part of the lower cover 34 and a part of the casing 30 and then bending the cut parts toward the mounting space.

Each groove part (reference numeral omitted) where the yoke 26 is seated thereon and coupled thereto is formed in an upper end of the lower support unit 320 and a lower end of the upper support unit 322. Therefore, the yoke 26 is capable of being rigidly and stably fixed to a determined position (substantially center) of the mounting space, so that dropping or separation of the yoke 26 may be prevented even by a large external impact such as a drop impact.

The vibration body 10 may be disposed in the mounting space formed by coupling the casing 30 and the lower cover 34 to each other such that the vibration body 10 is capable of reciprocating, i.e., vibrating, in the first direction. Furthermore, as the pair of elastic bodies 40L and 40R between the vibration body 10 and the casing 30 is elastically deformed according to the vibrations of the vibration body 10 in the first direction, the vibration amplitude of the vibration body 10 may be limited to a predetermined amplitude.

The vibration body 10 includes a frame part 12 which surrounds the fixed body 20 and to which the elastic bodies 40L and 40R are connected. In addition, the vibration body 10 is provided with a plurality of magnets 14A and 14B mounted on an inner surface of the frame part 12 facing the fixed body 20. Here, the frame part 12 may be formed of a first frame 12L and a second frame 12R in which parts of the first frame 12L and the second frame 12R are coupled to each other so that the parts overlap each other.

The first frame 12L and the second frame 12R may be coupled to each other such that each of the parts constituting the first frame 12L and the second frame 12R overlap each other from opposite sides of the fixed body 20. In addition, parts of the elastic bodies 40L and 40R may be inserted into and fixed to a region where the parts of the first frame 12L and the second frame 12R coupled to each other by overlapping each other from the opposite sides of the fixed body 20.

In an embodiment of the present disclosure, the lower cover 34, the casing 30, and the frame part 12 formed of the first frame 12L and the second frame 12R may be magnetic substances. Here, the term ‘magnetic substance’ may be an expression referring to a metal having a magnetic property.

The first frame 12L and the second frame 12R may be disposed symmetrically to each other in the first direction, and may be disposed such that the parts of the first frame 12L and the second frame 12R overlap each other in the second direction. Each of the first frame 12L and the second frame 12R may include a pair of fastening frames 126 disposed parallel to the first direction and a connection frame 120 connecting each first side end portion of the pair of fastening frames 126 to each other (see FIG. 2 and FIG. 4).

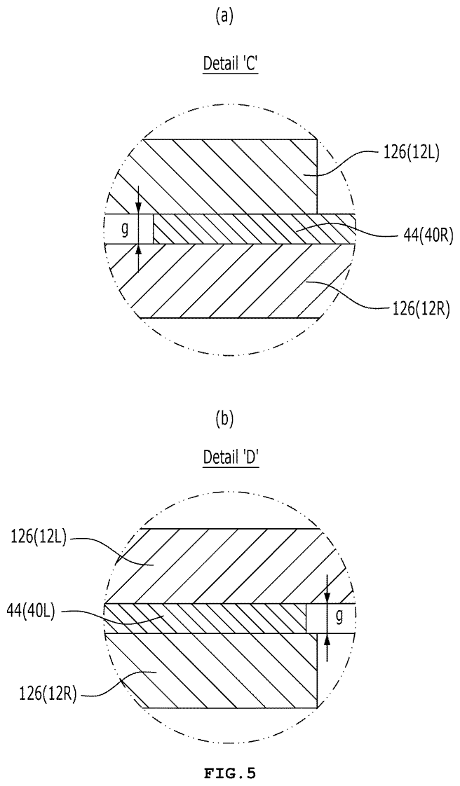

A recessed surface part 122 may be formed on the connection frame 120 of the first frame 12L and on the connection frame 120 of the second frame 12R. In addition, the fastening frame 126 of the first frame 12L and the fastening frame 126 of the second frame 12R that are positioned in the same direction with respect to the fixed body 20 may be coupled to each other so as to overlap each other and to parallel to each other as illustrated in FIG. 4 to FIG. 5(b), and may overlap each other and may be coupled to each other such that a gap g is formed in the overlapping region.

A first fastening hole 128-1 to which a first fastening protrusion 127-1 formed on an end of a first side of the fastening frame 126 forming the second frame 12R is engaged and fastened may be formed on an edge region of a first side of the first frame 12L.

In addition, a second fastening hole 128-2 to which a second fastening protrusion 127-2 formed on an end of a second side of the fastening frame 126 forming the first frame 12L is engaged and fastened may be formed on an edge region of a second side of the second frame 12R facing the first fastening hole 128-1 in a diagonal direction. Therefore, the first frame 12L and the second frame 12R may be rigidly fastened to each other by having the parts thereof being engaged and coupled to each other.

The plurality of magnets 14A and 14B forming the vibration body 10 may be formed of two first magnets 14A and two second magnets 14B. The two first magnets 14A may be disposed such that the two first magnets 14A face each other in the first direction with the fixed body 20 interposed therebetween, and the two second magnets 14B may be disposed such that the two second magnets 14B face each other in the second direction with the fixed 20 interposed body therebetween.

The two first magnets 14A may be mounted on the recessed surface part 122 formed on the connection frame 120 of the first frame 12L corresponding to a front surface part of the fixed body 20 (a left end portion of the fixed body in FIG. 4), and may be mounted on the recessed surface part 122 formed on the connection frame 120 of the second frame 12R corresponding to a rear surface part of the fixed body 20 (a right end portion of the fixed body in FIG. 4), respectively.

In addition, the two second magnets 14B may be mounted on a surface of the fastening frame 126 that is directly facing a first side surface part of the fixed body 20 in the second direction among the pair of fastening frames 126 forming the first frame 12L, and may be mounted on a surface of the fastening frame 126 that is directly facing a second side surface part of the fixed body 20 among the pair of fastening frames 126 forming the second frame 12R, respectively.

As the first magnet 14A and the connecting frame 120 are disposed in a structure that surrounds the fixed body 20 from the opposite sides of the fixed body 20 in the first direction, a circulation-type magnetic loop in which a magnetic force line continuously circulates in a specific direction when power is applied is formed, and each of the fastening frames 126 that overlaps each other surrounds the circulation-type magnetic loop from the opposite sides of the fixed body 20 in the second direction, so that magnetic leakage to the outside in the second direction may be more reliably suppressed or blocked.

A current is applied to the coil 24 of the fixed body 20 through the substrate (not illustrated), and the coil 24 is magnetized by the applied current. In addition, a force (Lorenz force) is generated by an interaction between the magnetized coil 24 and the second magnet 14B. In addition, due to the force, the vibration body 10 vibrates in the first direction in response to a frequency response characteristic determined according to the mass of the vibration body 10 and the elastic modulus of the elastic bodies 40L and 40R.

The elastic bodies 40L and 40R may be formed of a first elastic body 40L and a second elastic body 40R. The first elastic body 40L elastically supports vibrations of the vibration body 10 in the first direction from the first side of the vibration body 10, and the second elastic body 40R elastically supports the vibrations of the vibration body 10 in the first direction from the second side of the vibration body 10. Preferably, each of the first elastic body 40L and the second elastic body 40R includes a fixing end 42 coupled to the casing 30 and a movable end 44 coupled to the gap g such that a part of the movable end 44 is inserted into the gap g.

Positions on the plane of the fixed end 42 and the movable end 44 of the first elastic body 40L and positions on the plane of the fixed end 42 and the movable end 44 of the second elastic body 40R may be opposite to each other as illustrated in FIG. 4, and the movable end 44 and the fixed end 42 of the first elastic body 40L may be connected to each other and the movable end 44 and the fixed end 42 of the second elastic body 40R may be connected to each other via each connection part 43 respectively formed on the first elastic body 40L and the second elastic body 40R.

At this time, the connection part 43 may be formed in a diagonal structure in which the connection part 43 is gradually further away from the vibration body 10 from the movable end 44 to the fixed end 42.

As illustrated in the enlarged views in FIG. 5(a) and FIG. 5(b) illustrating the main configurations, each movable end 44 of the first elastic body 40L and the second elastic body 40R may be inserted into and coupled to each gap g that is formed in a region where the parts of the first frame 12L and the second frame 12R overlap each other and are parallel to each other in the first direction.

Preferably, by spot welding performed on the fastening frame 126 while each movable end 44 is inserted into each gap g, the fastening frame 126 and the movable end 44 may be rigidly coupled to each other in a state in which the fastening frame and the movable end 44 are disposed in a sandwich structure.

According to such a configuration, by adjusting an insertion depth of the movable end 44 to the gap g, an effect of adjusting each length of the elastic bodies 40L and 40R Therefore, an effect that the vibration is realized. frequency band of the vibration body 10 is capable of being adjusted in a product assembly process, and each fixing position of the elastic bodies 40L and 40R to the vibration body 10 is capable of being adjusted to a position capable of realizing an intended vibration characteristic, so that the variability of vibration performance according to component dispersion may be minimized.

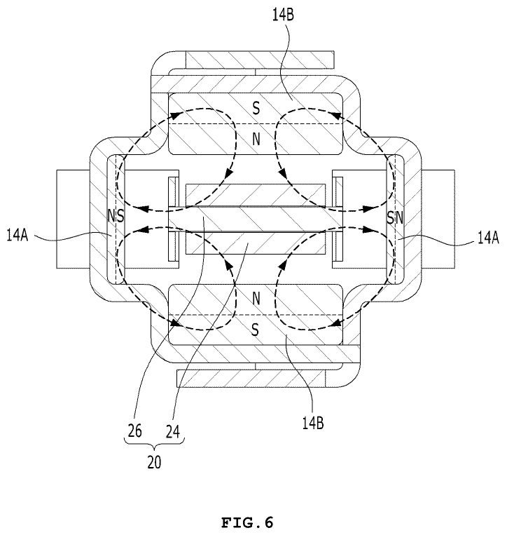

FIG. 6 is an enlarged view of the main configuration of the present disclosure, the enlarged view illustrating a preferred magnetic pole arrangement of the magnets forming the vibration body. Referring to FIG. 6, the first magnet 14A may be disposed such that an S-pole is positioned on a side facing the fixed body 20 and an N-pole is positioned on an opposite side. In addition, the second magnet 14B may be disposed such that an N-pole is positioned on a side facing the fixed body 20 and an S-pole is positioned on an opposite side.

According to the magnetic pole arrangement as described above, since a plurality of circulation-type magnetic loops such as arrows in FIG. 6 is formed, magnetic flux at the side of the second magnet 14, which functions as a driving magnet, facing the fixed body 20 is concentrated, and magnetic leakage at the opposite side may be significantly reduced. Particularly, since the magnetic loop is formed along a shorter path, a magnetic loop reduction effect may be realized.

Although not illustrated, contrary to the magnetic pole arrangement in FIG. 6, the first magnet 14A may be disposed such that the N-pole is positioned on the side facing the fixed body 20 and the S-pole is positioned on the opposite side, and the second magnet 14B may be disposed such that the S-pole is positioned on the side facing the fixed body 20 and the N-pole is positioned on the opposite side.

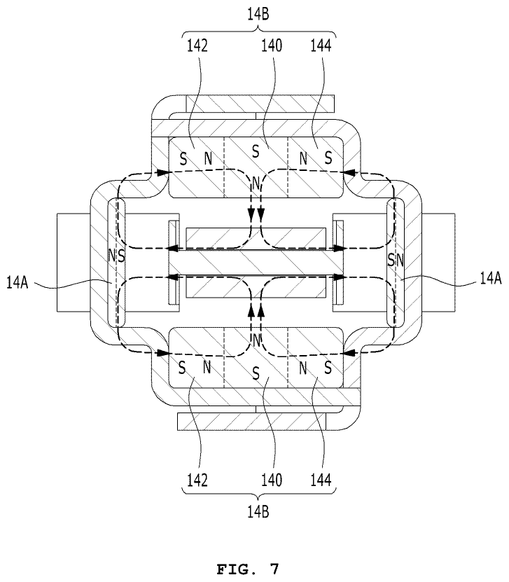

FIG. 7 is an enlarged view of the main configuration of the present disclosure, the enlarged view illustrating another preferred magnetic pole arrangement. As in the preferred embodiment in FIG. 6, the first magnet 14A may be disposed such that the S-pole is positioned on the side facing the fixed body 20 and the N-pole is positioned on the opposite side, but the second magnet 14B may be formed of a polarization magnet in which magnetic poles are divided into a plurality of magnetic poles unlike the embodiment in FIG. 5(a) and FIG. 5(b).

In the present embodiment, preferably, the second magnet 14B includes a magnet center part 140 and magnet side parts 142 and 144 positioned on opposite sides of the magnet center part 140. Furthermore, the magnet center part 140 may be configured such that an N-pole is formed at a side facing the fixed body 20 and an S-pole is formed at an opposite side, and the magnet side parts 142 and 144 may be configured such that an N-pole is formed at a side adjacent to the magnet center part 140 and an S-pole is formed at a side farther from the magnet center part 140.

According to such a configuration, a loop-type (circulation-type) magnetic circuit is formed, wherein the second magnet 14B functioning as the driving magnet has a relatively high magnetic flux density at a side of the second magnet 14B facing the fixed body 20 and has a relatively low magnetic flux density at a side of the second magnet 14B facing the casing 30. Therefore, the vibration force and the reaction speed (responsiveness) are significantly increased, and the magnetic flux leaking to the outside is reduced, so that the magnetic efficiency may be increased.

That is, according to the unique magnetic pole arrangement as illustrated in FIG. 7, there is an effect that an intensity of the magnetic field at a side substantially generating the vibration force is increased by the interaction between the coil and the second magnet and, accordingly, a drive force according to the interaction between the second magnet and the coil is increased, so that an attraction force, a repulsive force, a propulsive force of the vibration body against the fixed body 20 are increased, thereby being capable of increasing the vibration force and the reaction speed (responsiveness).

Although not illustrated here, the magnetic poles may be arranged as opposed to the magnetic pole arrangement in FIG. 7. That is, in FIG. 7, since the magnetic pole arrangement in which the position of the N-pole and the position of the S-pole are changed from each other is capable of being realized, which may also be included in the scope of the present disclosure.

According to an embodiment of the present disclosure, since a structure in which the magnetic substance frame (the first frame and the second frame) included in the vibration body completely surrounds the fixed body is realized, a magnetic closed circuit is formed in an XY plane direction (see FIG. 4), and the fixed body is supported on the support part formed on the magnetic substance casing and the lower cover, so that a magnetic closed circuit may be formed in an XZ plane direction (see FIG. 3).

Accordingly, since a more advanced magnetic shielding effect is realized, magnetic leakage to the outside of the casing may be suppressed or minimized. As a result, the drive force according to the interaction between the magnet and the coil is increased, so that the attraction force, the repulsive force, and the propulsive force of the vibration body against the fixed body are increased, thereby being capable of increasing the overall vibration performance including the vibration force and the reaction speed (responsiveness).

In addition, since the structure in which the part of the elastic body is inserted into and fixed to the overlapping region of the magnetic substance frame is realized, there is an advantage that the vibration frequency band of the vibration body is capable of being adjusted during the product assembly process by adjusting the insertion depth of the elastic body, and also the fixing position of the elastic body to the vibration body is capable of being adjusted to a position capable of realizing the intended vibration characteristic, so that the variability of vibration performance according to component dispersion may be minimized.

In addition, due to a unique connection structure (a sandwich-type connection structure) in which the part of the elastic body is inserted into and fixed to the overlapping region of the magnetic substance frame, durability problems such as a fracture of the elastic body frequently occurring at a connection region where the elastic body and the vibration body are connected to each other may be clearly and precisely resolved.

In the detailed description of the present disclosure described above, only a specific embodiment was described. However, the present disclosure should not be construed as being limited to the specific embodiment described above, but should be construed as including all changes, equivalents, and substitutions within the spirit of the present disclosure defined in the claims.

[Description of Reference Numerals]

| | |
|---|---|
| 1: Linear vibration generating apparatus | 10: Vibration body |
| 12: Frame part | 12L: First frame |
| 12R: Second frame | 14A: First magnet |
| 14B: Second Magnet | 20: Fixed body |
| 24: Coil | 26: Yoke |
| 30: Casing | 32: Support part |
| 34: Lower cover | 40L: First elastic body |
| 40R: Second elastic body | 42: Fixed end |
| 43: Connection part | 44: Movable end |
| 120: Connection frame | 122: Recessed surface part |
| 126: Fastening frame | 128-1, 128-2: Fastening hole |
| 320: Lower support unit | 322: Upper support unit |

1-10. (canceled)

11. A linear vibration generating apparatus comprising:
a casing coupled to a lower cover so that a mounting space is formed inside the casing;
a vibration body configured to vibrate in the mounting space in a first direction;
a fixed body comprising a coil surrounded by the vibration body and comprising a yoke to which the coil is wound; and
a pair of elastic bodies elastically supporting vibrations of the vibration body from between the casing and the vibration body,
wherein the vibration body comprises:
a frame part to which each of the pair of elastic bodies is connected; and
a plurality of magnets mounted on an inner surface of the frame part,
wherein the frame part is formed of a first frame and a second frame that are coupled to each other such that a part of the first frame and a part of the second frame overlap each other from opposite sides of the fixed body, and
each part of the elastic bodies is inserted into and fixed to a gap at a region where the first frame and the second frame overlap each other.

12. The linear vibration generating apparatus of claim 11, wherein the pair of elastic bodies is formed of a first elastic body elastically supporting the vibrations of the vibration body on a first side of the vibration body and a second elastic body elastically supporting the vibrations of the vibration body on a second side of the vibration body,
wherein each of the first elastic body and the second elastic body comprises:
a fixed end coupled to the casing;
a movable end coupled to the gap such that a part of the movable end is inserted into the gap; and
a connection part connecting the movable end and the fixed end to each other,
wherein positions on a plane of the fixed end and the movable end of the first elastic body are opposite to positions on a plane of the fixed end and the movable end of the second elastic body.

13. The linear vibration generating apparatus of claim 12, wherein a vibration frequency band of the vibration body is adjusted by adjusting an insertion length of the movable end that is inserted into the gap.

14. The linear vibration generating apparatus of claim 11, wherein each of the first frame and the second frame comprises:
a pair of fastening frames disposed parallel to each other with the fixed body interposed therebetween; and
a connection frame interconnecting each first side end portion of the pair of fastening frames,
wherein the fastening frames of the first frame and the fastening frames of the second frame are coupled to each other so as to be parallel to each other and to overlap each other.

15. The linear vibration generating apparatus of claim 14, wherein a first fastening hole for fastening the first frame to the second frame is formed in a first side edge region of the first frame, and
a second fastening hole for fastening the second frame to the first frame is formed in a second side edge region of the second frame, the second side edge region facing the first fastening hole in a diagonal direction.

16. The linear vibration generating apparatus of claim 14, wherein the plurality of magnets comprises:
a first magnet which is mounted on a recessed surface part formed on the first frame corresponding to a front surface part of the fixed body and which is mounted on a recessed surface part formed on the second frame corresponding to a rear surface part of the fixed body, respectively; and
a second magnet which is mounted on a surface of one fastening frame that is directly facing a first side surface part of the fixed body among the pair of fastening frames of the first frame and which is mounted on a surface of one fastening frame that is directly facing a second side surface part of the fixed body among the pair of fastening frames of the second frame, respectively.

17. The linear vibration generating apparatus of claim 11, further comprising:
a support part supporting the fixed body formed of the coil and the yoke so that the fixed body is positioned at a center of the mounting space.

18. The linear vibration generating apparatus of claim 17, wherein the support part comprises:
a pair of lower support units provided on the lower cover; and
a pair of upper support units provided on the casing such that the pair of upper support units corresponds to the pair of lower support units.

19. The linear vibration generating apparatus of claim 18, wherein the pair of lower support units and the pair of upper support units are formed by cutting a part of the lower cover and a part of the casing and then bending the cut parts toward the mounting space.

20. The linear vibration generating apparatus of claim 11, wherein the lower cover, the casing, and the frame part are formed of metal having magnetic properties.
